(19) United States
(12) Patent Application Publication
(10) Pub. No.: US 2012/0210362 A1
(43) Pub. Date: Aug. 16, 2012

(54) SYSTEM AND METHOD FOR PLAYING INTERNET PROTOCOL TELEVISION USING ELECTRONIC DEVICE

(75) Inventors: CHUNG-I LEE, Tu-Cheng (TW); CHIEN-FA YEH, Tu-Cheng (TW); SHAN-CHUAN JENG, Tu-Cheng (TW); CHENG-FENG TSAI, Tu-Cheng (TW); HO-I SUN, Tu-Cheng (TW)

(73) Assignee: HON HAI PRECISION INDUSTRY CO., LTD., Tu-Cheng (TW)

(21) Appl. No.: 13/339,537

(22) Filed: Dec. 29, 2011

(30) Foreign Application Priority Data
Feb. 14, 2011 (TW) 100104835

(51) Int. Cl. H04N 21/482

(52) U.S. Cl. 725/51

(57) ABSTRACT

An electronic device controls a client to play videos using internet protocol television (IPTV). The electronic device includes a display. The display displays a program list that includes a plurality of programs, a play option for activating play of a user selected television program and a browse option for activating display of information of the user selected television program. Videos of the programs are stored in an IPTV server connected to the client. In response to the user selects a television program on the display, the client obtains a video of the selected television program and displays the video on the client. If the user selects the browse option, the client obtains the information of the selected television program. The display of the electronic device displays the information of the selected television program.

### BACKGROUND

1. Technical Field

Embodiments of the present disclosure relate to internet protocol television (IPTV) management systems and methods, and more particularly to a system and method for playing IPTV using an electronic device.

2. Description of Related Art

Internet Protocol television (IPTV) is a system through which television services are delivered using the Internet protocol suite over a packet-switched network such as the Internet, instead of being delivered through traditional terrestrial, satellite signal, and cable television formats. Users can use IPTV via some electronic devices. The electronic device may be computers, mobile phones, or televisions. At present, if the user wants to play IPTV using a television, a keyboard and a mouse are needed. It is not convenient for users to use the keyboard and the mouse.

### BRIEF DESCRIPTION OF THE DRAWINGS

FIG. 1 is a block diagram of one embodiment of an electronic device comprising a control system.

FIG. 2 is a block diagram of one embodiment of the function modules of the control system in FIG. 1.

FIG. 3 is a flowchart illustrating one embodiment of a method for playing IPTV using the electronic device.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

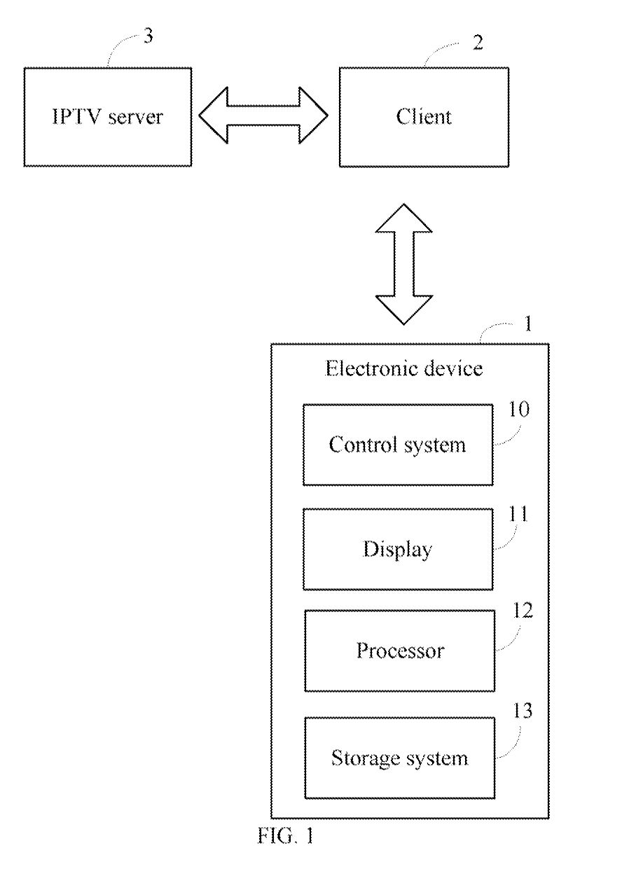

FIG. 1 is a block diagram of one embodiment of an electronic device 1 comprising a control system 10. The electronic device 1 further comprises a display 11. In one embodiment, the electronic device 1 may be a mobile phone or a music player, for example. The display 11 displays a user interface, which displays a television program list that includes a plurality of television programs and information of each television program. In one embodiment, the television programs may be movies, television series, or operas, for example. Information of a television program may include a name, a brief introduction, actor information, and director information of the television program, for example. The user interface also provides a play option for activating play of a user selected television program and a browse option for activating display of information of the user selected television program. In one embodiment, the display 11 may be a touch screen.

The electronic device 1 is electronically connected to a client 2. In one embodiment, the client 2 may be a combination of a television and a top box, a mobile phone, or a computer, for example. The communication between the electronic device 1 and the client 2 may be via infrared ray, or a wireless network, or electric wires. The client 2 is connected with an IPTV server 3. The IPTV server 3 stores all videos of the television programs and the information of the television programs. The client 2 plays the videos of the television programs or displays the information of the television programs according to operation of users on the electronic device 1. In one embodiment, the IPTV server 3 may be video sites (like YouTube).

In an exemplary embodiment, the electronic device 1 includes at least one processor 12 and a storage system 13. The control system 10 may include one or more modules. The one or more modules may comprise computerized code in the form of one or more programs that are stored in the storage system 13 (or memory). In one embodiment, the storage system 13 may be a magnetic or an optical storage system, such as a flash memory, or other suitable storage medium. The computerized code includes instructions that are executed by the at least one processor 12 to provide functions for the one or more modules.

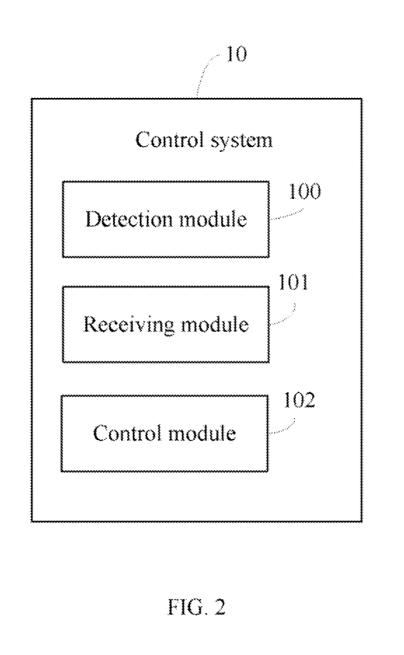

As shown in FIG. 2, the control system 10 may include a detection module 100, a receiving module 101, and a control module 102.

The detection module 100 detects if the play option is selected after the client 2 is started. If the play option is not selected, the detection module 100 detects if the browse option is selected. In one embodiment, the user can select the play option by pressing a select key of a keyboard of the electronic device 1, or select by touching a button of the play option on the display 11 if the display 11 is the touch screen, for example.

If the play option is selected, the receiving module 101 receives a playing mode and a television program selected by a user from the television program list. In one embodiment, the user can select the playing mode of the television program by touching a button of the playing mode on the display 11, for example. The playing mode includes a network mode and a traditional mode. The network mode is a mode to play the videos of the selected television program on the client 2 via an internet protocol television (IPTV). The traditional mode is a mode to play the videos of the selected television program on the client 2 via cable.

The control module 102 sends a playing command to the client 2 according to the playing mode, to control the client 2 to play the videos of the selected television program stored in the IPTV server 3. The client 2 sends a video request command to the IPTV server 3 for the selected television program after receiving the playing command. The IPTV server 3 sends the selected television program to the client 2 in response to the video request command, and then the client 2 plays the video of the selected television program. In some embodiments, video formats of the selected television program may be “.flv”, “.f4v”, “.mp4”, or “.mov.”

If the browse option is selected, the receiving module 101 receives a television program selected by the user from the television program list.

The control module 102 sends an information request command to the client 2 to obtain the information of the selected television program from the client 2. As mentioned above, the information of the selected television program may include a name, a brief introduction, actor information, director information, for example.

The detection module 100 detects if the user selects to play a video of the selected television program. If the user has selected to play the video of the selected television program, the control module 102 controls the client 2 to obtain the video of the selected television program from the IPTV server 3 and to play the video on the client 2.

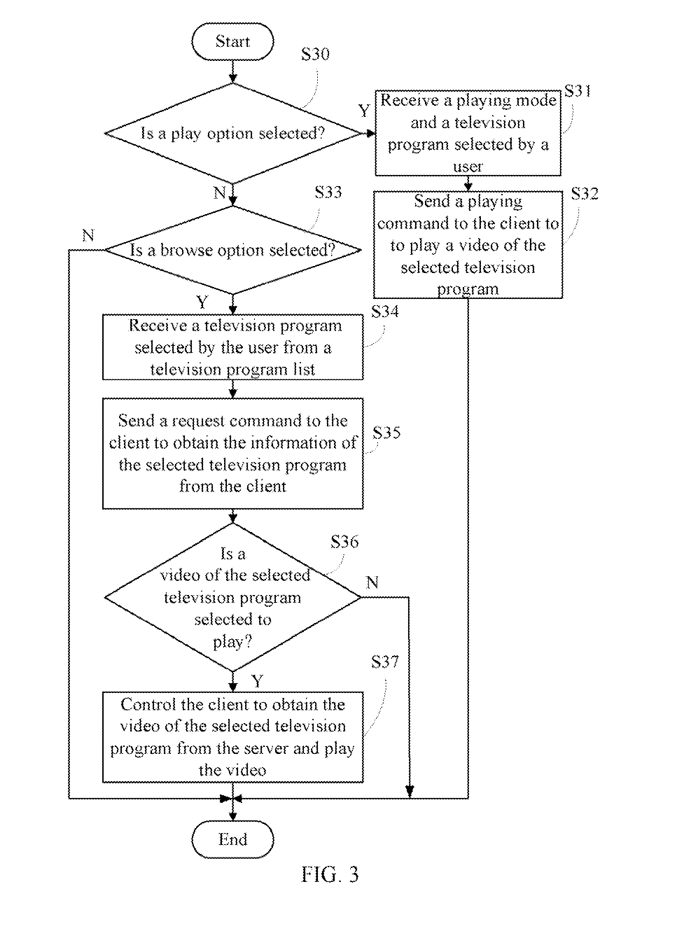

FIG. 3 is a flowchart illustrating a method for playing internet protocol television using electronic device. Depending on the embodiment, additional blocks may be added, others removed, and the ordering of the blocks may be changed.

In block S30, the detection module 100 detects if the play option is selected after the client 2 is started. If the play option is selected, block S31 is implemented. If the play option is not selected, block S33 is implemented.

In block S31, the receiving module 101 receives a playing mode and a television program selected by a user. The playing mode includes a network mode and a traditional mode.

In block S32, the control module 102 sends a playing command to the client 2 according to the playing mode, to control the client 2 to play the videos of the selected television program stored on the IPTV server 3.

In block S33, the detection module 100 detects if the user selects the browse option. If the user selects the browse option, block S34 is implemented. If the user does not select the browse option, procedure ends. In one embodiment, if the user does not select browse option, the user may select to close the client 2.

In block S34, the receiving module 101 receives a television program selected by the user from the television program list.

In block S35, the control module 102 sends a request command to the client 2 to obtain the information of the selected television program from the client 2.

In block S36, the detection module 100 detects if the user selects to play a video of the selected television program. If the user has selected to play the video of the selected television program, block S37 is implemented. If the user has not selected to play the video of the selected television program, procedure ends.

In block S37, the control module 102 controls the client to obtain the video of the selected television program from the IPTV server and to play the video on the client 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a display;
a storage system;
at least one processor; and
one or more programs being stored in the storage system and executable by the at least one processor, the one or more programs comprising:
a receiving module operable to receive a playing mode and a television program selected from a television program list displayed on a user interface of the display in response to activation of a play option displayed on the user interface, the play option for playing videos of the selected television program;
a control module operable to control a client connected to the electronic device to play the selected television program stored in an IPTV server connected to the client according to the playing mode; and
the control module further operable to send an information request command to the client in response to activation of a browse option displayed on the user interface, the browse information for display of information of the selected television program, the information request command receiving the information of the selected television program from the IPTV server and displaying the information of the selected television program on the display.

2. The electronic device as described in claim 1, wherein the playing mode comprises a network mode and a traditional mode.

3. The electronic device as described in claim 1, wherein the IPTV server stores the videos and the information of the videos.

4. A computer-based method for playing internet protocol television using an electronic device, comprising:
receiving a playing mode and a television program selected from a television program list displayed on a user interface of a display of the electronic device in response to activation of a play option displayed on the user interface, the play option for playing videos of the selected television program;
controlling a client connected to the electronic device to play the selected television program stored in an IPTV server connected to the client according to the playing mode;
sending an information request command to the client to control the client in response to activation of a browse option displayed on the user interface, the browse option for display of information of the selected television program; and
obtaining the information of the selected television program from the IPTV server, and displaying the information of the selected television program on the display.

5. The method as described in claim 4, wherein the playing mode comprises a network mode and a traditional mode.

6. The method as described in claim 4, wherein the IPTV server stores the videos and the information of the videos.

7. A non-transitory storage medium having stored thereon instructions that, when executed by a processor, cause the processor to perform a method for playing internet protocol television using an electronic device, the method comprising:
receiving a playing mode and a television program selected from a television program list displayed on a user interface of a display of the electronic device in response to activation of a play option displayed on the user interface, the play option for playing videos of the selected television program;
controlling a client connected to the electronic device to play the selected television program stored in an IPTV server connected to the client according to the playing mode;
sending an information request command to the client to control the client in response to activation of a browse option displayed on the user interface, the browse option for display of information of the selected television program; and
obtaining the information of the selected television program from the IPTV server, and displaying the information of the selected television program on the display.

8. The non-transitory storage medium as described in claim 7, wherein the playing mode comprises a network mode and a traditional mode.

9. The non-transitory storage medium as described in claim 7, wherein the IPTV server stores the videos and the information of the videos.
